(19) United States
(12) Patent Application Publication
(10) Pub. No.: US 2010/0310962 A1
(43) Pub. Date: Dec. 9, 2010

(54) FUEL CELL STACK WITH TRANSPARENT FLOW PATHWAYS AND BIPOLAR PLATES THEREOF

(75) Inventors: Feng-Chang Chen, Taipei (TW); Seng-Woon Lim, Taipei (TW); Chi-Bin Wu, Taipei (TW)

Correspondence Address: STITES & HARBISON PLLC., Suite 900, 1199 N. Fairfax Street, Alexandria, VA, 22314, US

(73) Assignee: Chung-Hsin Electric and Machinery Manufacturing Corp., Jhonghe City (TW)

(21) Appl. No.: 12/504,018

(22) Filed: Jul. 16, 2009

(30) Foreign Application Priority Data
Jun. 4, 2009 (TW) 098118506

(51) Int. Cl. H01M 2/02

(52) U.S. Cl. 429/457

(57) ABSTRACT

A fuel cell stack with transparent flow pathways and bipolar plates thereof are provided. The fuel cell stack includes at least one membrane electrode assembly (MEA) and at least one pair of bipolar plates. Each bipolar plate includes a transparent flowing path plate and a current collector. Each MEA is interposed between two corresponding bipolar plates so that power generated by each MEA is transmitted through the current collectors disposed respectively on margins of adjacent ones of the transparent flowing path plates. The transparent flowing path plates allow the production of liquid water in the fuel cell stack to be monitored in real time from outside the fuel cell stack, so as to prevent flow pathways of the transparent flowing path plates from being blocked and thereby maintain the efficiency of power generation of the fuel cell stack.

### BACKGROUND OF THE INVENTION

1. Technical Field

The present invention relates to fuel cell stacks with transparent flow pathways and bipolar plates thereof. More particularly, the present invention relates to a fuel cell stack provided with transparent flow pathways and configured for use with a fuel cell, and bipolar plates of the fuel cell stack.

2. Description of Related Art

A fuel cell is a low-noise, low-pollution, recharging-free, and high-efficiency power-generating device. Given continuous supply of fuel, electrochemical reaction takes place in the fuel cell continuously to generate electrical energy. Fuel supplied to the fuel cell, such as methanol, ethanol, hydrogen, or related hydrocarbons, reacts with an oxidizing agent like oxygen to generate electrical energy. Also, as a byproduct, water is produced by the electrochemical reaction.

Inside the fuel cell, the fuel is conveyed via flow pathways, and thus the efficiency of power generation of the fuel cell depends on how good the flow pathways are at conveyance. If water produced by the fuel cell is not drained therefrom, it will accumulate and clog the flow pathways. With the flow pathways being clogged up with water, electrochemical reaction in the fuel cell decreases, thereby deteriorating the performance of the fuel cell.

Taiwan Patent No. 1236178, titled “The Technology of Making Transparent Fuel Cell for Observing Water Flooding”, disclosed forming a bipolar plate by coupling a transparent plate to a side of a conductive flow field plate so as for flow pathways inside the bipolar plate to be observed by means of the transparent plate. Thus, the inside of the flow pathways is clearly visible, and it is convenient to observe and understand how water is produced and distributed in a fuel cell unit during operation.

The prior art taught coupling a transparent plate to an opaque conductive flow field plate so as for flow pathways inside the conductive flow field plate to be readily observed. However, with a fuel cell stack being formed from a plurality of fuel cell units, and the transparent plates being sandwiched between other components in the fuel cell stack, only the internal condition of the flow pathways in the outermost fuel cell units can be observed through the corresponding transparent plates. The transparent plates in the remaining fuel cell units are sandwiched between other components in the fuel cell stack and thus do not allow observation therethrough. Hence, in case of clogged flow pathways deep inside the fuel cell stack, it is impossible to find such clogged flow pathways by observing through the transparent plates.

### BRIEF SUMMARY OF THE INVENTION

It is an objective of the present invention to provide a fuel cell stack with transparent flow pathways and bipolar plates thereof, wherein transparent flowing path plates are provided in each of a plurality of fuel cell units, and a fuel cell stack is formed from the fuel cell units, such that production and accumulation of water in the fuel cell stack can be observed through each of the transparent flowing path plates, and real-time monitoring of the flow pathways is thereby effectuated.

Another objective of the present invention is to provide a fuel cell stack with transparent flow pathways and bipolar plates thereof, wherein clogging of the flow pathways can be observed in real time through transparent flowing path plates, so as to avoid possible deterioration of fuel cell performance.

Yet another objective of the present invention is to provide a fuel cell stack with transparent flow pathways and bipolar plates thereof, wherein transparent flowing path plates are made of a non-metallic material so as to effectively reduce the costs of the resulting fuel cell and render the fuel cell lightweight.

To achieve the above and other objectives, the present invention provides a fuel cell stack with transparent flow pathways, comprising: at least a membrane electrode assembly and at least a pair of bipolar plates sandwiched together with a said membrane electrode assembly, wherein the bipolar plates each comprise a transparent flowing path plate and at least a current collector coupled to a margin of the transparent flowing path plate.

To achieve the above and other objectives, the present invention further provides a bipolar plate with transparent flow pathways, comprising: a transparent flowing path plate and at least a current collector coupled to a margin of the transparent flowing path plate.

Implementation of the present invention at least involves the following inventive steps:

1. With a plurality of transparent flowing path plates being provided in a fuel cell stack, production and distribution of water in the fuel cell stack can be observed from the outside in a direct and real-time manner.

2. Real-time observation of the production of water in the fuel cell stack helps prevent clogging of the flow pathways in the fuel cell stack.

3. With the transparent flowing path plates being made of a non-metallic material, costs of the fuel cell stack are reduced, and the fuel cell stack thus fabricated is lightweight.

### BRIEF DESCRIPTION OF THE SEVERAL VIEWS OF THE DRAWINGS

The invention as well as a preferred mode of use, further objectives, and advantages thereof will be best understood by referring to the following detailed description of illustrative embodiments in conjunction with the accompanying drawing, wherein:

FIG. 1 is an exploded perspective view of an embodiment of a fuel cell stack with transparent flow pathways according to the present invention;

FIG. 2 is an assembled perspective view of the fuel cell stack shown in FIG. 1;

FIG. 3A is a perspective view of an embodiment of a bipolar plate with transparent flow pathways according to the present invention;

FIG. 3B is a perspective view of another embodiment of the bipolar plate with transparent flow pathways according to the present invention;

FIG. 4A is a perspective view of yet another embodiment of the bipolar plate with transparent flow pathways according to the present invention;

FIG. 4B is a perspective view of a further embodiment of the bipolar plate with transparent flow pathways according to the present invention; and

FIG. 5 is a perspective view of another embodiment of the fuel cell stack with transparent flow pathways according to the present invention.

### DETAILED DESCRIPTION OF THE INVENTION

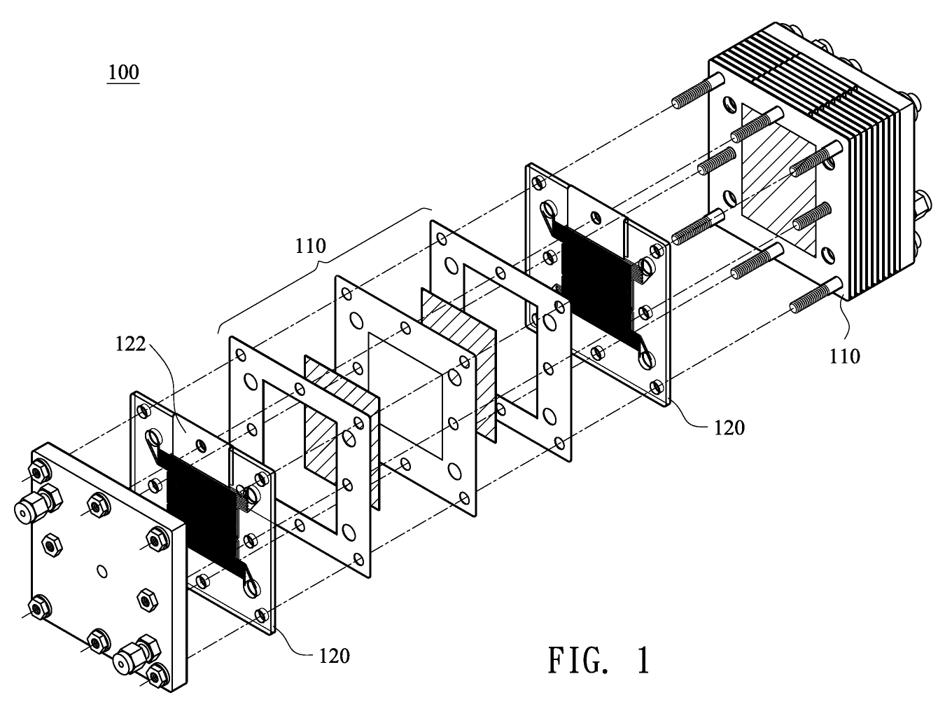

Referring to FIG. 1, which is an exploded perspective view of a fuel cell stack 100 with transparent flow pathways according to the present invention, the fuel cell stack 100 comprises at least a membrane electrode assembly 110 and at least a pair of bipolar plates 120. The fuel cell stack 100 comprises a plurality of fuel cell units stacked up. Each of the fuel cell units comprises a said membrane electrode assembly 110 and a pair of said bipolar plates 120.

The membrane electrode assembly 110 comprises a proton exchange membrane, two catalyst layers, and two gas diffusion layers. Once an oxidizing agent and fuel cross the gas diffusion layers and enter the membrane electrode assembly 110, electrochemical reaction will begin to take place in the membrane electrode assembly 110 to produce electrons and water.

Electrons produced by each said membrane electrode assembly 110 are conveyed by a current collector 122 positioned on an adjacent said bipolar plate 120. In so doing, the fuel cell stack 100 generates electric current. Hence, the number of the membrane electrode assemblies 110 provided in the fuel cell stack 100 determines how much electric power the fuel cell stack 100 can generate.

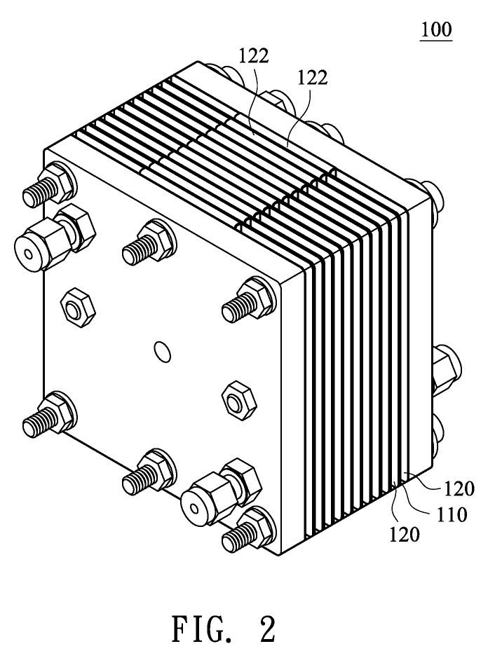

Referring to FIG. 1 and FIG. 2, each two adjacent bipolar plates 120 are sandwiched together with a said membrane electrode assembly 110 such that the membrane electrode assembly 110 is disposed between the two bipolar plates 120. Electrons produced by the membrane electrode assembly 110 are delivered to a neighboring said membrane electrode assembly 110 via the current collector 122 of an adjacent said bipolar plate 120 so as for electric current produced by the membrane electrode assembly 110 to be delivered across the fuel cell stack 100.

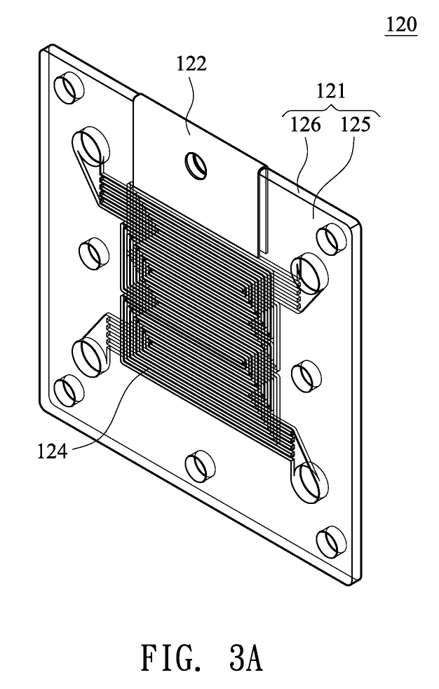

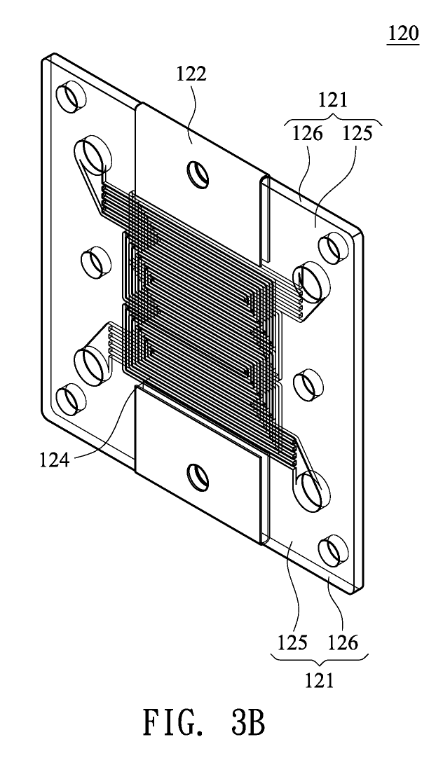

Referring to FIG. 3A, each of the bipolar plates 120 comprises a transparent flowing path plate 121 and at least a said current collector 122. The transparent flowing path plate 121 is provided with a plurality of transparent flow pathways 124 therein. The current collector 122 is coupled to a margin 125 of the transparent flowing path plate 121. The current collector 122 extends outward to cover a side edge 126 of the transparent flowing path plate 121.

The current collector 122 is a U-shaped plate disposed straddlingly on the side edge 126 of the transparent flowing path plate 121. Hence, the current collector 122 is coupled double-sidedly to two side surfaces of the margin 125 of the transparent flowing path plate 121.

Referring to FIG. 3B, the bipolar plate 120 is provided with two said current collectors 122. The current collectors 122 are coupled to two corresponding margins 125 of the transparent flowing path plate 121, respectively. The current collectors 122 extend outward to cover two corresponding side edges 126 of the transparent flowing path plate 121, respectively. Each of the two current collectors 122 is coupled double-sidedly to two side surfaces of the corresponding margin 125 of the transparent flowing path plate 121 so as to increase the contact area between the current collectors 122 and the adjacent membrane electrode assemblies 110, thereby increasing the speed of electron delivery and enhancing the efficiency of power generation by the fuel cell stack 100.

As the current collectors 122 are coupled to the margins 125 of the transparent flowing path plate 121, the current collectors 122 of two neighboring said transparent flowing path plates 121 can be connected by wiring so as to form electrical connection. Hence, the current collectors 122 provided on the transparent flowing path plate 121 substitute for a standalone current collector and thereby render the fuel cell stack 100 lightweight.

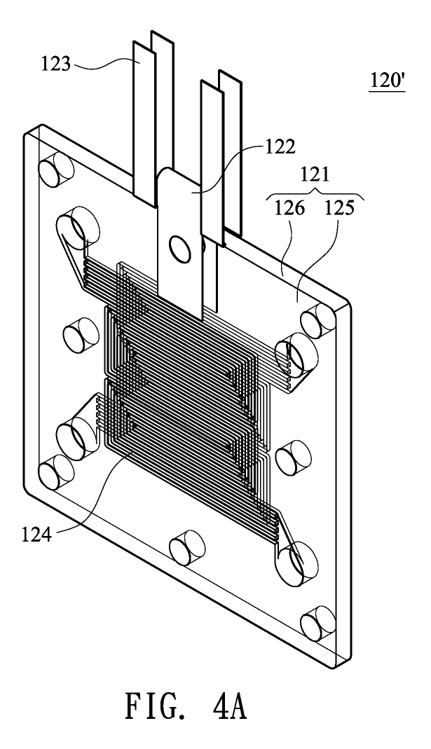

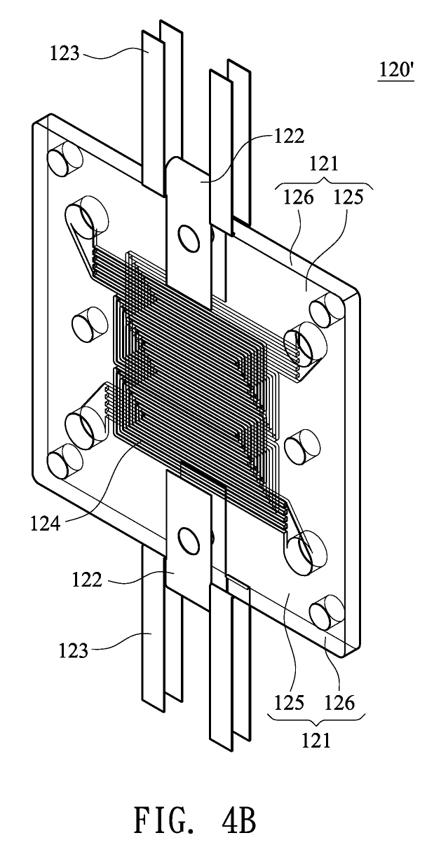

Referring to FIG. 4A, the current collector 122 on a bipolar plate 120′ is further provided with at least a heat-dissipating element 123, wherein each of the at least a heat-dissipating element 123 extends from the current collector 122 to outside the transparent flowing path plate 121. The at least a heat-dissipating element 123 is thermally coupled to the current collector 122. Hence, heat generated by electrochemical reaction taking place in the adjacent membrane electrode assemblies 110 is dissipated by the at least a heat-dissipating element 123 thermally coupled to the current collector 122, so as to prevent excessive waste heat from accumulating in the adjacent membrane electrode assemblies 110 which might otherwise affect the speed of electrochemical reaction taking place in the membrane electrode assemblies 110.

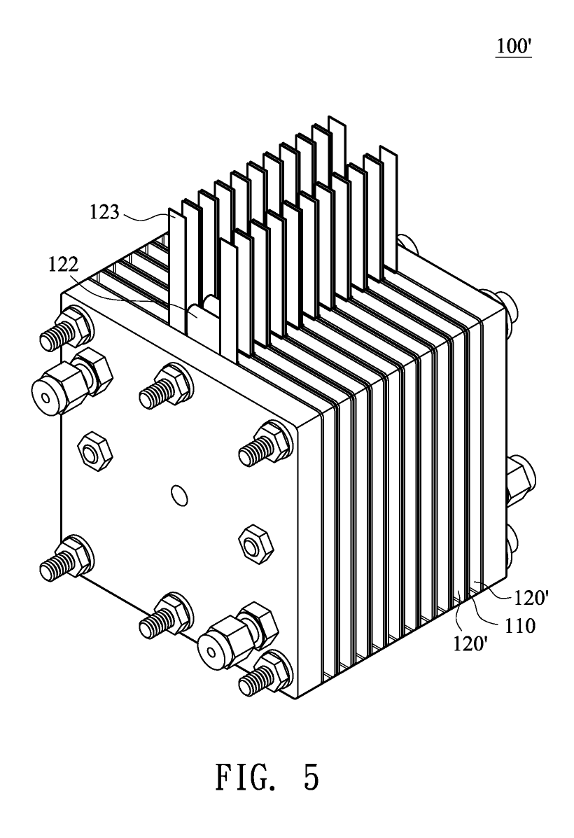

Referring to FIG. 4B, the bipolar plate 120′ is bilaterally provided with the current collectors 122, and each of the current collectors 122 is further provided with at least a said heat-dissipating element 123 to facilitate quick removal of heat from the adjacent membrane electrode assemblies 110, such that electrochemical reaction takes place in the membrane electrode assemblies 110 steadily. Referring to FIG. 5, which is a perspective view of a fuel cell stack 100′ comprising the bipolar plates 120′ provided with the heat-dissipating elements 123, the heat-dissipating elements 123 are thermally coupled to the current collectors 122 such that waste heat generated by electrochemical reaction taking place in the fuel cell stack 100′ is quickly dissipated by the heat-dissipating elements 123 so as for the fuel cell stack 100′ to supply power steadily.

The transparent flowing path plate 121 is made of a non-conductive material such as polymer, glass, or solid-state oxide so as to be lightweight and incur relatively low costs. Consequently, weight and costs of the resulting fuel cell stack 100, 100′ are also reduced.

Since the flow pathways 124 of each of the transparent flowing path plates 121 are transparent and visible, production and distribution of water in the transparent flow pathways 124 of the fuel cell stack 100, 100′ (as shown in FIG. 2 and FIG. 5) can be directly observed from the outside so as to discover clogging of the flow pathways 124 in a real-time manner.

The current collector 122 is a conductive thin plate. Hence, the current collector 122 is coupled to the transparent flowing path plate 121 by insert molding, hot pressing, gluing, or ultrasonic welding so as to speed up fabrication of the bipolar plates 120, 120′ and simplify the fabrication process of the bipolar plates 120, 120′.

The above embodiments serve to expound the technical solutions disclosed in the present invention rather than limit the present invention. All equivalent changes or modification made to the present invention by a person skilled in the art without departing from the spirit of the present invention should fall within the scope of the present invention.

What is claimed is:

1. A fuel cell stack with transparent flow pathways, comprising:
at least a membrane electrode assembly; and
at least a pair of bipolar plates sandwiched together with a said membrane electrode assembly, each said bipolar plate comprising a transparent flowing path plate and at least a current collector coupled to a margin of the transparent flowing path plate.

2. The fuel cell stack of claim 1, wherein each said current collector extends to cover a side edge of a corresponding said transparent flowing path plate.

3. The fuel cell stack of claim 2, wherein each said current collector is coupled double-sidedly to the margin of a corresponding said transparent flowing path plate.

4. The fuel cell stack of claim 1, wherein each said bipolar plate is provided with two said current collectors coupled to two said margins of a corresponding said transparent flowing path plate, respectively.

5. The fuel cell stack of claim 4, wherein each said current collector extends to cover a side edge of a corresponding said transparent flowing path plate.

6. The fuel cell stack of claim 5, wherein the current collectors are coupled double-sidedly to two said margins of a corresponding said transparent flowing path plate, respectively.

7. The fuel cell stack of claim 1, wherein each said transparent flowing path plate is made of polymer, glass, solid-state oxide, or a non-conductive material.

8. The fuel cell stack of claim 1, wherein each said current collector is a conductive thin plate.

9. The fuel cell stack of claim 1, wherein each said current collector is further provided with at least a heat-dissipating element extending from the each said current collector to outside a corresponding said transparent flowing path plate, the at least a heat-dissipating element being thermally coupled to the each said current collector.

10. The fuel cell stack of claim 1, wherein each said current collector is coupled to a corresponding said transparent flowing path plate by insert molding, hot pressing, or gluing.

11. A bipolar plate with transparent flow pathways, comprising:
a transparent flowing path plate; and
at least a current collector coupled to a margin of the transparent flowing path plate.

12. The bipolar plate of claim 11, wherein each said current collector extends to cover a side edge of the transparent flowing path plate.

13. The bipolar plate of claim 12, wherein each said current collector is coupled double-sidedly to the margin of the transparent flowing path plate.

14. The bipolar plate of claim 11, comprising two said current collectors, wherein the current collectors are coupled to two said margins of the transparent flowing path plate, respectively.

15. The bipolar plate of claim 14, wherein each said current collector extends to cover a side edge of the transparent flowing path plate.

16. The bipolar plate of claim 15, wherein the current collectors are coupled double-sidedly to two said margins of the transparent flowing path plate, respectively.

17. The bipolar plate of claim 11, wherein the transparent flowing path plate is made of polymer, glass, solid-state oxide, or a non-conductive material.

18. The bipolar plate of claim 11, wherein each said current collector is a conductive thin plate.

19. The bipolar plate of claim 11, wherein each said current collector is further provided with at least a heat-dissipating element extending from the each said current collector to outside the transparent flowing path plate, the at least a heat-dissipating element being thermally coupled to the each said current collector.

20. The bipolar plate of claim 11, wherein each said current collector is coupled to the transparent flowing path plate by insert molding, hot pressing, or gluing.
